(19) United States
(12) Patent Application Publication
(10) Pub. No.: US 2020/0384841 A1
(43) Pub. Date: Dec. 10, 2020

(54) ACCUMULATOR ARRANGEMENT

(71) Applicant: Mahle International GmbH, Stuttgart (DE)

(72) Inventors: Stefan Hirsch, Stuttgart (DE); Michael Moser, Ellwangen (DE); Heiko Neff, Auenwald (DE); Mario Wallisch, Aichtal (DE)

(21) Appl. No.: 16/608,525

(22) PCT Filed: Apr. 10, 2018
(86) PCT No.: PCT/EP2018/059166

§ 371 Date: Oct. 25, 2019

(30) Foreign Application Priority Data
Apr. 26, 2017 (DE) 10 2017 206 986.4

(51) Int. Cl. B60K 1/04; B60L 58/26; B62D 21/15; H01M 2/10; H01M 10/613; H01M 10/625; H01M 10/6568

(52) U.S. Cl. CPC B60K 1/04; B60L 58/26; B62D 21/15; H01M 2/1083; H01M 2220/20; H01M 10/625; H01M 10/6568; B60K 2001/0438; B60K 2001/0472; H01M 10/613

(57) ABSTRACT

An accumulator arrangement for a motor vehicle may include a receiving space configured to receive at least one battery module, a supply arrangement arranged in the receiving space, and a protective cover at least partially closing the receiving space. The supply arrangement may be configured to supply the at least one battery module. The receiving space may be defined by a recess disposed in a chassis of the motor vehicle. The supply arrangement may be formed directly on an underside of the chassis. The supply arrangement may have at least one first interface operatively connected to the at least one battery module via at least one second interface of the battery module. One of the at least one first interface and the at least one second interface may be insertable into the other one of the at least one first interface and the at least one second interface.

### CROSS-REFERENCE TO RELATED APPLICATIONS

This application claims priority to International Patent Application No. PCT/EP2018/059166, filed on Apr. 10, 2018, and German Patent Application No. DE 10 2017 206 986.4, filed on Apr. 26, 2017, the contents of both of which are hereby incorporated by reference in their entirety.

### TECHNICAL FIELD

The present invention relates to an accumulator arrangement, in particular for a motor vehicle, with a receiving space to receive at least one battery module, with a supply arrangement, arranged in the receiving space, which is provided for supplying the at least one battery module, and with a protective cover which at least partially closes the receiving space.

### BACKGROUND

In today's electrically operated motor vehicles, so-called traction batteries come into use for the storage of electrical energy. The traction batteries are often formed from several battery modules interconnected electrically with one another, which are arranged in an accumulator housing provided for this, which is preferably sealed. These accumulator housings serve to protect the electronics from external influences and generally consist of a housing upper shell and a housing lower shell. Generally, such accumulator housings have a high requirement in particular with regard to tightness, owing to the in part very high voltages of the individual battery modules. An exchange of such battery modules meanwhile constitutes a great installation effort, because as a rule the battery modules per se must be dismantled together with the accumulator housing, in order to be able to open said accumulator housing at all.

From DE 10 2012 012 891 A1 a device is generally known for the connecting of at least two battery modules, arranged in at least one row, in a battery case of a vehicle, which battery modules are adjacent to one another with the interposition of a connection plate. The connection plate has, for this, on one module side, centring elements which project in corresponding centring openings of the two battery modules which are adjacent to one another. In addition, in particular on the opposite module side, a connection element is provided which is functionally decoupled from the connection plate and which connects with one another the two battery modules, adjacent to one another, on the opposite module side. The battery case, formed from an upper shell and a lower shell, dips here into a centre tunnel of a motor vehicle body floor.

It is disadvantageous in the present prior art that for example for the maintenance of individual battery modules generally the entire traction battery, i.e. the entire accumulator housing, including the battery modules arranged therein, has to be dismantled. As the traction batteries are relatively large and very heavy, the effort for the installation and dismantling is extremely laborious and, in addition, cost-intensive. Furthermore, the current accumulator housings are not at all, or only to a very limited extent, of use for increasing a structural strength of the vehicle body as such.

### SUMMARY

The present invention is therefore concerned with the problem of indicating, for an accumulator arrangement of the type named in the introduction, an improved or at least alternative embodiment, which in particular at least partly overcomes the disadvantages described above and in addition is able to be produced in a favourably-priced manner by a simplified manufacture.

This problem is solved according to the invention by the subject of the independent claim(s). Advantageous embodiments are the subject of the dependent claim(s).

The present invention is based on the general idea, in an accumulator arrangement, of forming a receiving space to receive at least one battery module directly by a recess formed on an underside of a chassis of the motor vehicle, and to provide a supply arrangement for supplying the at least one battery module directly on precisely this underside of a wall of the chassis delimiting the recess. The supply arrangement has here at least a first interface which is in operative connection with the at least one battery module. Through the provision of a so-called “plug & play” connection in the form of the at least one first interface of the supply arrangement, it is therefore possible to mount individual battery modules into the accumulator arrangement or to dismantle them from the accumulator arrangement without an upstream laborious dismantling of the entire traction battery. By the recess on the underside of the chassis and the receiving space which is thereby formed, in accordance with the invention a separate housing upper shell and separate lateral housing walls are dispensed with, so that the receiving space, except for the protective cover, is delimited by the chassis. Consequently, the chassis represents at least partially such an accumulator housing. This is advantageous in particular with respect to an improved structural strength of the vehicle body. A separate accumulator housing is only suitable to a limited extent for increasing the structural strength, whereas in the solution according to the invention, the accumulator housing, as part of the chassis, therefore contributes fully to the structural strength of the vehicle body. The accumulator arrangement has, for this, the receiving chamber for receiving the at least one battery module, the supply arrangement arranged in the receiving space, which is provided for supplying the at least one battery module, and a protective cover, which at least partially closes the receiving space. The receiving space formed by the recess on the chassis substitutes, according to the invention, a conventional housing upper shell, by the at least one battery module being surrounded indirectly and/or directly at least partially directly by the chassis. The described accumulator arrangement simplifies the maintenance possibility of battery modules to a considerable extent, because only the protective cover has to be dismantled for the delivery or removal of the respective battery modules.

In an advantageous embodiment of the accumulator arrangement according to the invention, the at least one battery module also has at least a second interface, which is formed in a complementary manner to the at least one first interface of the supply arrangement, so that the at least one battery module is in operative connection with the supply arrangement. Preferably, the first interface and the second interface are respectively embodied so as to be insertable, so that a quick delivery or removal is made possible. It is to be stated that both the at least one first interface on the supply arrangement and also the second interface on the at least one battery module can be shaped in any desired manner.

A further advantageous embodiment makes provision that the at least one first interface on the supply arrangement and the at least one second interface on the battery module comprise in particular at least one electrical connection line for an electrical on-board supply system, and/or at least one signal line for a battery management system and/or at least one electrical line for a thermal management and/or at least one pipeline for directing a fluid and/or at least one fastening arrangement. All conceivable connections between the supply arrangement and the at least one battery module are also protected within the scope of this invention. The indicated operative connections between the supply arrangement and precisely the at least one battery module can come into use respectively alone or in combination.

Expediently, provision can be made that the at least one first interface on the supply arrangement, and the at least one second interface on the battery module comprise at least one electrical line and at least one pipeline for directing a fluid. Therefore, electrical and fluidic connections are integrated in the interfaces, in order to simplify mounting.

An embodiment is particularly advantageous in which the fluid is used for cooling the respective battery module. The fluid is then thus a coolant. A cooling liquid is particularly efficient here. The respective battery module can expediently be configured so that, in addition to battery cells, it also has a cooling structure which is able to be flowed through by the respective coolant. Therefore, the complete logistics for cooling the battery cells can be provided within the battery module. This simplifies the structure of the receiving space on the vehicle side. Accordingly, the respective battery module can have a cooling structure able to be flowed through by the cooling liquid, which cooling structure is fluidically connected with the respective second interface.

A further development is particularly advantageous, in which a dry space surrounding the respective battery module is formed in the receiving space, which dry space is free of cooling liquid. In other words, the battery modules are not flowed around by the respective coolant in the receiving space. The coolant flows exclusively in the battery modules, which improves the efficiency of the cooling.

In an advantageous further development, the at least one battery module is able to be inserted and also able to be removed in Z direction along the wall of the supply arrangement delimiting the recess. This means that the at least one battery module, with respect to the example with the use in a motor vehicle, is able to be inserted from below upwards into the receiving space, provided for this, on the chassis of the motor vehicle.

A further expedient further development makes provision that the at least one first interface on the supply arrangement and the at least one second interface on the battery module are insertable. This means that the at least one first interface on the supply arrangement is formed for example as a socket and the at least one second interface on the battery module is formed as a plug. As previously described, the plug and the socket are formed in a complementary manner to one another, so that with an inserting of such a battery module, therefore the movement in the direction of the supply arrangement along the Z axis, the previously described socket on the supply arrangement receives the plug of the battery module and establishes an operative connection.

In a preferred further development of the idea according to the invention, a fastening arrangement, provided on the supply arrangement, is formed as a detachable form-fitting and/or force-fitting operative connection. The fastening arrangement therefore serves for a fixing of the at least one battery module. For this, the fastening arrangement is formed in such a way that it can bear at least the intrinsic weight of the at least one battery module. This serves in particular for safety on mounting and dismantling, because the at least one battery module is secured against an undesired detaching from the supply arrangement or respectively against an undesired falling out from the receiving space. The fastening arrangement is preferably configured as a detent connection, which is formed in such a way that with the latter the at least one battery module can be fixed or respectively engaged on the supply arrangement, in particular in Z direction. Particularly preferably, the fastening arrangement is formed as a spring detent connection, so that in addition to the simple engaging, also with the aid of a spring a releasing of the detent connection is made possible in the simplest manner.

Expediently, the protective cover of the accumulator arrangement is formed in such a way that it closes the receiving space, in particular in a fluid-tight manner. This means that the protective cover delimits, at least on one side, the receiving space formed by the recess on the chassis.

In an advantageous embodiment, the protective cover lies directly against the underside of the chassis and covers here at least the region of the recess or, in other words, the region of the open side of the receiving space.

An expedient further development makes provision that the protective cover is held by means of a holding device, in particular a screw connection, on the underside of the chassis. For example, the holding device can be arranged in a region of an overlapping of the protective cover to the recess. It is also conceivable that the protective cover is held by means of a holding device on the underside of the wall of the chassis delimiting the recess.

In a further expedient further development, a seal, in particular a closed circumferential ring seal, is provided between the protective cover and the underside of the chassis, which ring seal is preferably pressed at least partially between the protective cover and the underside of the chassis. The sealing serves substantially for the protection of the electronics in the region of the receiving space. The arrangement of a circumferential ring seal constitutes a favourably-priced and effective sealing of the electronics which are to be protected.

A preferred further development of the accumulator arrangement according to the invention makes provision that the protective cover has a positioning arrangement on a side facing the recess in the region of the receiving space, in particular in the region of the at least one battery module, which positioning arrangement is formed in such a way that it aligns the at least one battery module in the receiving space and in particular at least partially fixes it. With a closing of the receiving space by means of the protective cover, the protective cover is to be moved along the Z axis in the direction of the supply arrangement. Here, the individual battery modules arranged in the receiving space are positioned suitably by the positioning arrangement and finally fixed in a form-fitting manner.

Furthermore, in addition to the previously described partial fixing of the at least one battery module by means of the positioning arrangement, a further fixing of the at least one battery module can be provided in an additional embodiment. Here, the at least one battery module is fixed securely on the protective cover by means of at least one screw connection, in particular with several screw connections. For this, for example a thread is provided on the at least one battery module, wherein the protective cover has a through-bore concentrically to the thread, through which a screw, formed in a complementary manner to the thread, is able to be directed. It is also conceivable that the thread is arranged in the region of the through-bore and the screw, in the screwed-in state, presses the at least one battery module in Z direction against the supply arrangement or respectively against the underside of the wall of the chassis delimiting the recess, and braces it therewith.

A further development of the previously described embodiment makes provision that a screw of the screw connection between the protective cover and the respective battery module establishes or separates an electrical connection between at least two battery modules according to the extent of screwing-in of the screw. This means that on mounting of the protective cover by means of a screw connection, precisely these screw connections can likewise establish the electrical connections between at least two battery modules. This takes place preferably by insertion of at least one screw per module connection. In addition, the contacting between the battery modules is preferably embodied in a resilient manner, so that, vice versa, on loosening of the screws or respectively removing of the screws, the electrical connections between the at least two battery modules are separated again. Through the advantageous further development, the opening of the receiving space of the battery modules is only possible when no electrical connections exist between the individual battery modules. This configuration significantly increases the safety from an electric shock during the dismantling of individual battery modules. In this embodiment, the screws of the screw connection are preferably free of any electrical potential at any time. For this, the screws can have an insulator for example on a side facing away from the screw head, which insulator separates the screw from the electric flux of the electrical connection.

In a further embodiment, the protective cover is held between the chassis and a vehicle underride protection. For example, the protective cover, by a fixing of the motor vehicle underride protection, is pressed between precisely the latter and the underside of the chassis. The simplified dismantling of the individual battery modules is advantageous here, because only the motor vehicle underride protection has to be unfastened, in order to reach the said battery modules.

The arrangement according to the invention can come into use in any desired application. It is conceivable, in particular, to use the arrangement in a motor vehicle. Here, the accumulator can be used in the motor vehicle for powering the motor vehicle.

A motor vehicle according to the invention with such a previously described accumulator arrangement has at least one protective cover, wherein the protective cover is formed in particular with a motor vehicle underride protection in one piece or respectively monolithically. Therefore the accumulator housing, known from the prior art, of a housing upper shell and a housing lower shell, is entirely integrated into already present vehicle components. In other words, through the introduction of the previously described recess, the chassis represents the housing upper shell, and the motor vehicle underride protection constitutes the housing lower shell, so that a separate conventional accumulator housing can be dispensed with entirely.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically,

FIG. 1 a schematic diagram of an accumulator arrangement according to the invention with a receiving space, closed by a protective cover, for receiving at least one battery module,

FIG. 2 the schematic diagram of FIG. 1 with a protective cover arranged in a non-closed manner and with battery modules arranged in a detached manner,

FIG. 3 a variant embodiment of the accumulator arrangement according to the invention, wherein the protective cover is formed in one piece or respectively monolithically with a motor vehicle underride protection,

FIG. 4 the illustration of FIG. 3 with a non-closed receiving space and with battery modules arranged in a detached manner,

FIG. 5 a simplified detail illustration of a screw connection, which is formed on the underride protection, and in the state which is shown separates an electrical connection,

FIG. 6 the detail illustration of FIG. 5 in a state in which the screw connection closes such an electrical connection,

FIG. 7 a schematic diagram of an accumulator arrangement known from the prior art.

### DETAILED DESCRIPTION

FIG. 7, which is described first, shows a schematic diagram of an accumulator arrangement 1 known from the prior art. In the example which is shown, the accumulator arrangement 1 is arranged on an underside 7 of a chassis 8 of a motor vehicle 2. The accumulator arrangement 1 is formed here for example from two battery modules 4, which are arranged in an accumulator housing 28. The battery modules 4 can have several battery cells 29, wherein the battery modules 4 which are shown have, for example, respectively two battery cells 29. Expediently, the respective battery module 4 can have furthermore a cooling structure 16, indicated here by a pipe, for cooling the battery cells 29, which is able to be flowed through by an in particular liquid coolant 18. The accumulator housing 28 has a housing upper shell 30 and a housing lower shell 31, which form a tight receiving space 3 for the battery modules 4. Beneath the housing lower shell 31 in addition a motor vehicle underride protection 27 is arranged, which can be held in particular against the housing lower shell 31 and/or against the chassis 8. For removal of at least one respective such battery module 4, it is necessary to dismantle the entire accumulator housing 28 from the chassis 8 of the motor vehicle 2.

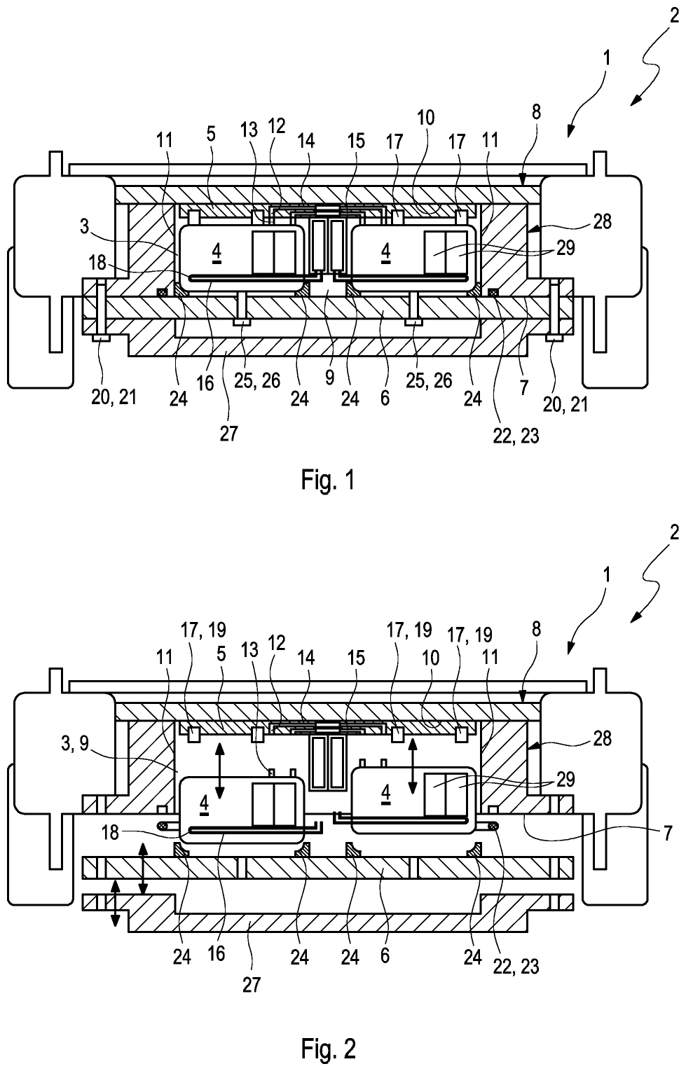

In FIG. 1 a schematic diagram of the accumulator arrangement 1 according to the invention, in particular for such a motor vehicle 2, is illustrated. The accumulator arrangement 1 is formed with such a receiving space 3, closed by a protective cover 6, for receiving at least one such battery module 4. The receiving space 3 is formed directly by a recess 9 formed on the underside 7 of the chassis 8 of the motor vehicle 2. The receiving space 3, formed by the recess 9 on the chassis 8, is therefore delimited at least partially by the chassis 8 per se. The recess 9 on the chassis 8 can therefore be designated at least as a part of the accumulator housing 28. The receiving space 3 is formed so as to be open only towards an underside of the motor vehicle. In the receiving space 3 a supply arrangement 5 is arranged, which is provided for the supply of the two battery modules 4, arranged by way of example. The supply arrangement 5 can be formed here directly on the underside 10 of a wall 11 of the chassis 8 delimiting the recess 9. Furthermore, the supply arrangement 5 can have at least a first interface 12, which is in operative connection with at least one such battery module 4. It is to be stated that in particular for each battery module 4 a respectively associated first interface 12 can be provided. The battery modules 4 can also have respectively at least a second interface 13, which are formed in a complementary manner to the respective first interfaces 12 of the supply arrangement 5. The first interfaces 12 and the second interfaces 13 can to that effect enable the operative connection between the battery modules 4 and the supply arrangement 5. The respective first interfaces 12 and the second interfaces 13 can be embodied so as to be insertable, so that the operative connection between the battery modules 4 and the supply arrangement 5 can be established simply and quickly. Inter alia, the first interfaces 12 and the second interfaces 13 can have at least one of the following connections; an electrical connection line 14 for an electrical on-board supply system, an electrical signal line 15 for example for a battery management system and/or for a thermal management, a pipeline, see the cooling structure 16, for directing a fluid, see the coolant 18, in particular for cooling the individual battery modules 4, a fastening arrangement 17 for fixing the individual battery modules 4 to the supply arrangement 5. In particular the respective second interface 13 can therefore be coupled in a communicating manner fluidically with the above-mentioned cooling structure 16 of the respective battery module 4. Through the integration, provided here, of the cooling into the battery modules 4, a through-flow of the receiving space 3 with the coolant 18 can be dispensed with. Therefore, in the receiving space 3 a dry space, not designated in further detail, can be formed, which is free of coolant and which surrounds the battery modules 4.

The protective cover 6 can lie directly against the underside 7 of the chassis 8. For a desired fluid-tight closing of the receiving space 3, the protective cover 6 can project in area over the recess 9 which at least partially forms the receiving space 3, so that the receiving space 3 is closed on all sides. The fixing of the protective cover 6 can take place by means of a holding device 20, which can be formed as a screw connection 21. Here, the protective cover 6 can be screwed onto the underside 7 of the chassis 8. In addition, a seal 22 can be arranged between the protective cover 6 and the underside 7 of the chassis 8. The seal 22 can preferably be formed as a ring seal 23 which runs around the recess 9 and is closed, so that the receiving space 3 is sealed toward the exterior. Moreover, the seal 22 can be at least partially pressed between the protective cover 6 and the underside 7 of the chassis 8.

The protective cover 6 can have, furthermore, a positioning arrangement 24 on a side facing the recess 9 or respectively the chassis 8, which positioning arrangement is formed in such a way that it can align and fix at least one such battery module 4 in the receiving space 3. The positioning arrangement 24 can be formed as a type of negative contour to the structure of the battery modules 4, so that the individual battery modules 4 can be held in a form-fitting manner against the protective cover 6. For this, an associated positioning arrangement 24 can be provided for each individual battery module 4. The aligning or respectively fixing of the battery modules 4 takes place on closing of the receiving space 3 by the protective cover 6. Substantially, the individual battery modules 4 can be pressed between the protective cover 6 and the supply arrangement 5 in Z direction at least in such a manner that they are arranged in the receiving space 3 in a securely fixed manner.

Moreover, the individual battery modules 4 can be fixed securely with the protective cover 6 respectively by means of a screw connection 25. For this, for example, a screw 26 of the screw connection 25 can be arranged in a thread, formed in a complementary manner to the screw 26, on the protective cover 6. On a screwing-in of such a screw 26 into the region of the receiving space 3, it presses against at least one such battery module 4 and braces the latter here in Z direction against the supply arrangement 5 or against the underside 10 of the wall 11 of the chassis 8 delimiting the recess 9. Preferably, for each battery module 4, at least one, particularly preferably several such screw connections 25 can be provided with such a screw 26 for fixing the respective battery modules 4.

FIG. 2 shows the schematic diagram of FIG. 1 with a protective cover 6 arranged in a non-closed manner and with battery modules 4 arranged in a detached manner. The individual battery modules 4 are able to be inserted or respectively removed in Z direction in the receiving space 3 which is provided for this. This means that the battery modules 4, in the application in a motor vehicle 2, are able to be attached to the supply arrangement 5 from the underside 7 of the chassis 8. The fastening arrangement 17 can bring about a pre-fixing of the individual battery modules 4 on the supply arrangement 5. The fastening arrangement 17 can be formed here for example as a spring detent connection 19 between at least one battery module 4 and the supply arrangement 5. The fastening arrangement 17 is preferably designed in such a way that it can bear at least the intrinsic weight of the battery module 4 which is to be fixed or respectively held.

It is conceivable that the protective cover 6 is clamped between the underside 7 of the chassis 8 and such a motor vehicle underride protection 27. Here, the motor vehicle underride protection 27 can be directly in connection with the underside 7 of the chassis 8 or indirectly through the interposed protective cover 6.

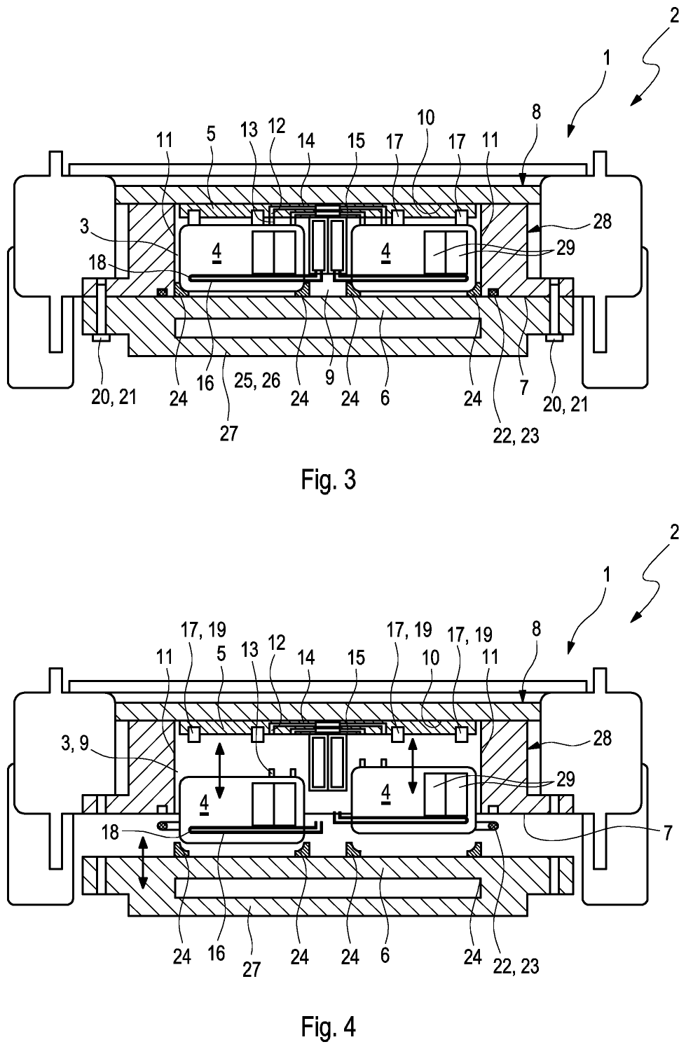

FIGS. 3 and 4 show a variant embodiment of the accumulator arrangement 1 according to the invention, wherein the protective cover 6 is formed in one piece or respectively monolithically with a motor vehicle underride protection 27. In this variant embodiment, all the previously described features of the protective cover 6 can be transferred directly to the motor vehicle underride protection 27. FIG. 4 represents a dismantled motor vehicle underride protection 27, whereby the removal of a battery module 4 is made possible.

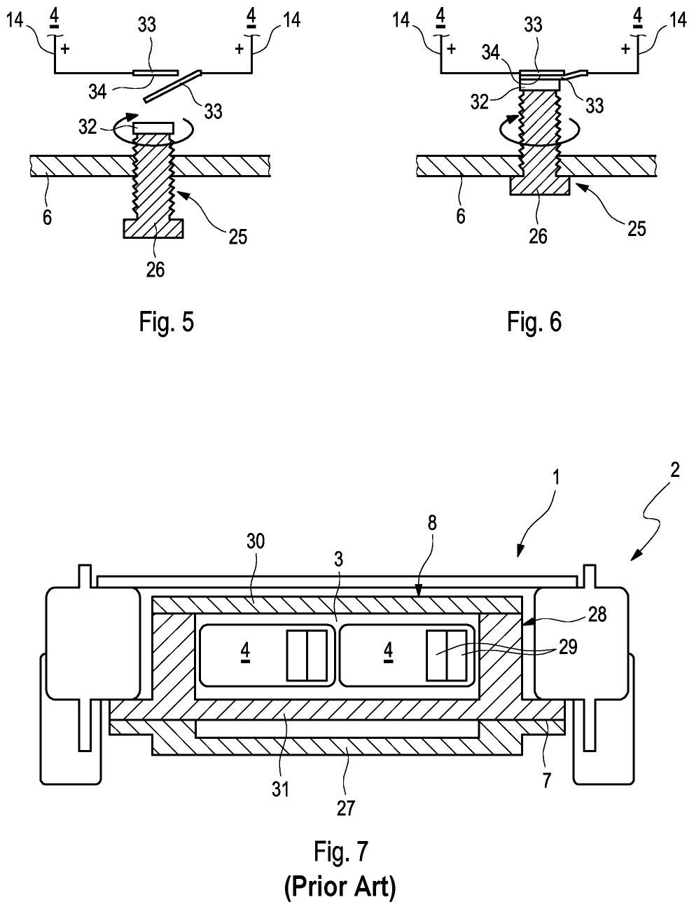

FIG. 5 and FIG. 6 show respectively a simplified detail illustration of a screw connection 25, which can be formed on the protective cover 6. The screw connection 25 is shown in two different screw-in states of a screw 26, whereby an electrical connection site 25 is separated or closed.

In FIG. 5 the screw 26 is illustrated in a screw-in state in which the electrical connection site 34 is separated. Here, respective contact sites 33 of the electrical connection lines 14 are not in direct contact, so that no electrical connection is closed between two battery modules 4. In FIG. 6, on the other hand, the screw 26 is illustrated in a screw-in state in which the electrical connection site 34 is closed. This means that the respective contact faces 33 are directly in connection with one another, so that the two electrical connection lines 14 are electrically connected with one another. It is to be stated that the screw 26 of the at least one screw connection 25 can be used likewise for fixing the protective cover 6. The screw connection 25 can therefore likewise enable the fixing of the protective cover 6 and also the electrical connection between two battery modules 4. The screw 26 can expediently have an insulator 32 at a longitudinal end facing away from the screw head, which insulator keeps the screw 26 free of any potential.

1.-19. (canceled)

20. An accumulator arrangement for a motor vehicle, comprising:
a receiving space configured to receive at least one battery module;
a supply arrangement arranged in the receiving space, the supply arrangement configured to supply the at least one battery module;
a protective cover at least partially closing the receiving space;
the receiving space defined directly by a recess disposed in an underside of a chassis of the motor vehicle;
the supply arrangement formed directly on an underside of a wall of the chassis delimiting the recess, and having at least one first interface operatively connected to the at least one battery module via at least one second interface of the at least one battery module structured in a complementary manner to the at least one first interface; and
wherein one of the at least one first interface and the at least one second interface is insertable into the other one of the at least one first interface and the at least one second interface.

21. The accumulator arrangement according to claim 20, wherein the at least one first interface and the at least one second interface respectively include at least one of:
at least one electrical connection line for an electrical on-board supply system;
at least one electrical signal line for a battery management system;
at least one electrical signal line for a thermal management system;
at least one pipeline for directing a fluid; and
at least one fastening arrangement.

22. The accumulator arrangement according to claim 20, wherein the at least one first interface and the at least one second interface respectively include at least one electrical line and at least one pipeline for directing a fluid.

23. The accumulator arrangement according to claim 22, wherein:
the fluid is a cooling liquid;
the at least one battery module includes a cooling structure through which the cooling liquid is flowable; and
the cooling structure is fluidically connected to the at least one second interface.

24. The accumulator arrangement according to claim 23, wherein the receiving space includes a dry space surrounding the at least one battery module, and wherein the dry space is free of the cooling liquid.

25. The accumulator arrangement according to claim 24, further comprising a fastening arrangement structured as a detent connection, the fastening arrangement coupling the at least one battery module on the supply arrangement.

26. The accumulator arrangement according to claim 20, wherein the at least one battery module is insertable into and removable from the receiving space in a Z direction extending along the wall of the supply arrangement delimiting the recess.

27. The accumulator arrangement according to claim 20, further comprising a fastening arrangement disposed on the supply arrangement, the fastening arrangement structured as at least one of a detachable form-fitting operative connection and a force-fitting operative connection.

28. The accumulator arrangement according to claim 27, wherein the protective cover is coupled via a holding device on the underside of the chassis.

29. The accumulator arrangement according to claim 28, wherein:
the at least one battery module includes a plurality of battery modules; and
via a screw of a screw connection between the protective cover and the at least one battery module, an electrical connection between at least two battery modules of the plurality of battery modules is establishable based on an extent of screwing-in of the screw.

30. The accumulator arrangement according to claim 28, wherein the holding device is structured as a screw connection.

31. The accumulator arrangement according to claim 27, further comprising a seal disposed between the protective cover and the underside of the chassis.

32. The accumulator arrangement according to claim 31, wherein the seal is structured as a closed circumferential ring seal.

33. The accumulator arrangement according to claim 20, wherein the protective cover closes the receiving space in a fluid-tight manner.

34. The accumulator arrangement according to claim 20, wherein the protective cover is disposed directly against the underside of the chassis and covers at least a region of the recess.

35. The accumulator arrangement according to claim 20, wherein the protective cover includes a positioning arrangement disposed on a side of the protective cover facing the recess in a region of the receiving space, the positioning arrangement configured to align the at least one battery module in the receiving space.

36. The accumulator arrangement according to claim 35, wherein the positioning arrangement is disposed in a region of the at least one battery module and is configured to at least partially secure the at least one battery module in the receiving space.

37. The accumulator arrangement according to claim 20, wherein the at least one battery module is secured on the protective cover via at least one screw connection.

38. The accumulator arrangement according to claim 20, wherein the protective cover is arranged between the chassis and a motor vehicle underride protection.

39. A motor vehicle, comprising an accumulator arrangement according to claim 20 and a motor vehicle underride protection, wherein the protective cover is at least one of (i) integrally provided as a single piece with the motor vehicle underride protection and (ii) structured monolithically with the motor vehicle underride protection.
